(19) United States
(12) Patent Application Publication
(10) Pub. No.: US 2006/0143024 A1
(43) Pub. Date: Jun. 29, 2006

(54) Methods and systems that calculate a projected utility of information technology recovery plans based on contractual agreements

(76) Inventors: Mathias J. R. Salle, San Francisco, CA (US); Claudio Bartouni, Menlo Park, CA (US); Abdel Boulmakoul, Bristol (GB); David Trastour, Bristol (GB); Athena Christodoulou, Bristol (GB); Christopher W. Preist, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/016,119

(22) Filed: Dec. 17, 2004

(51) Int. Cl. G06Q 99/00

(52) U.S. Cl. 705/1

(57) ABSTRACT

In at least some embodiments, an apparatus and method may receive parameters of an information technology (IT) infrastructure and formulate one or more IT recovery plans based on the parameters. The apparatus and method may further calculate a projected utility for one or more of the IT recovery plans based on one or more contractual agreements.

### BACKGROUND

An organization may utilize information technology (IT) to perform a variety of organizational tasks, such as providing data storage, facilitating communication, and automating services. An organization's IT infrastructure of computer systems, networks, databases, and software applications may be responsible for accomplishing these organizational tasks.

When a component of the IT infrastructure degrades or becomes faulty, the performance of services that depend upon the component may be adversely affected. To rectify this performance degradation, a decision-maker, such as an IT manager, may be presented with several business-related decisions. For example, one such decision may be whether to repair or replace the faulty component. Each decision may be associated with one or more plans, such as to replace the component today or repair the component next week when a technician is available.

The decision-maker may analyze each decision by determining the projected utility gain or loss associated with performing each plan. In some instances, the utility may be dependent on service level agreements (SLAs) and other types of contractual agreements the organization has formed with various parties, such as customers, suppliers, and distributors. Unfortunately, management tools operated by the decision-maker may not integrate contractual information into the decision-making processes, thereby reducing the accuracy of utility calculations and not enabling the decision-maker to make informed business decisions.

### BRIEF SUMMARY

In at least some embodiments, an apparatus and method may receive parameters of an information technology (IT) infrastructure and formulate one or more IT recovery plans based on the parameters. The apparatus and method may further calculate a projected utility for one or more of the IT recovery plans based on one or more contractual agreements.

### BRIEF DESCRIPTION OF THE DRAWINGS

For a detailed description of exemplary embodiments of the invention, reference will now be made to the accompanying drawings in which:

FIG. 1 illustrates a management model in accordance with embodiments of the invention;

FIG. 2 illustrates a contract-based analysis layer in accordance with embodiments of the invention;

FIG. 3 illustrates a flow diagram of contractual processing logic in accordance with embodiments of the invention;

FIG. 4 illustrates a class diagram of a resource model in accordance with embodiments of the invention;

FIG. 5 illustrates a class diagram of a service model in accordance with embodiments of the invention;

FIG. 6 illustrates a class diagram of a contract model in accordance with embodiments of the invention;

FIG. 7 illustrates a class diagram of an undertaking model in accordance with embodiments of the invention;

FIG. 8 illustrates a class diagram of a service level agreement (SLA) model in accordance with embodiments of the invention;

FIG. 9 shows a class diagram of service level objective (SLO) model in accordance with embodiments of the invention;

FIG. 10 illustrates a system in accordance with embodiments of the invention;

FIG. 11 illustrates a contractual processing application window in accordance with embodiments of the invention;

FIG. 12 illustrates contract utility information shown in a contractual processing application window in accordance with embodiments of the invention; and

FIG. 13 illustrates strategic utility information shown in a contractual processing application window in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more parts and may be used to refer to a computer system or a portion of a computer system.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be illustrative of that embodiment, and not intended to suggest that the scope of the disclosure, including the claims, is limited to that embodiment.

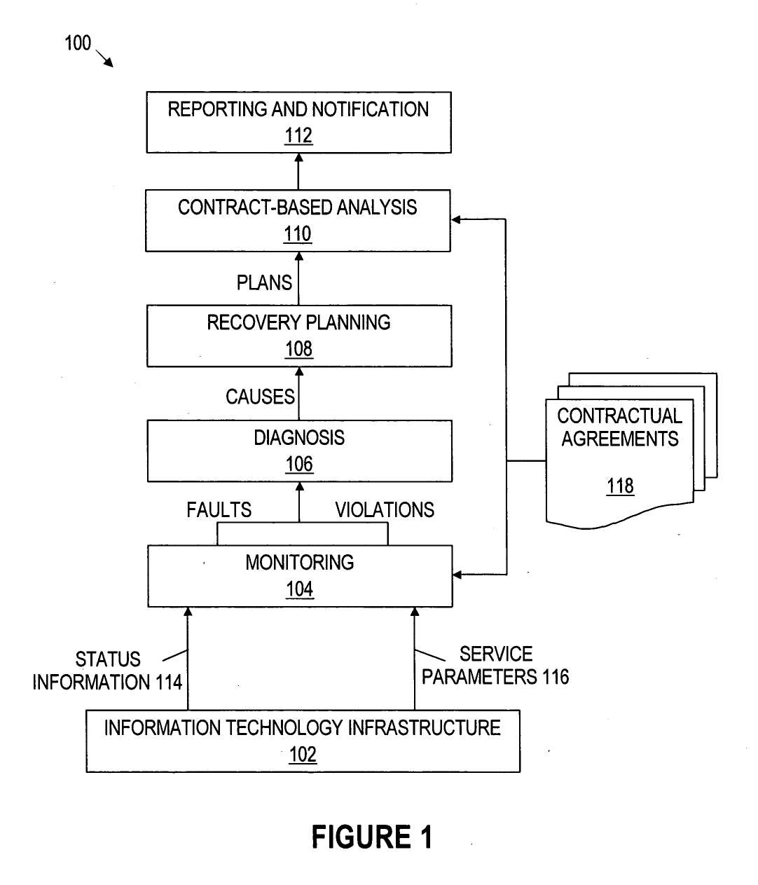

FIG. 1 illustrates a management model 100 in accordance with embodiments of the invention. As shown, the management model 100 comprises six layers 102-112. The bottom layer represents an organization's information technology (IT) infrastructure. The IT infrastructure 102 comprises the computer systems, networks, databases, and software applications that are responsible for performing organizational tasks, such as accounting, marketing, and electronic communications. A monitoring layer 104 may monitor the IT infrastructure 102 and obtain status information 114 and service parameters 116 from the IT infrastructure 102. The status information 114 may represent the operational status, such as active or inactive, of individual systems or components of the IT infrastructure 102. The service parameters 116 may represent measurable conditions associated with the services performed by the IT infrastructure 102. The service parameters 116 may include down-time, processing time, data throughout, time to delivery, and any other measurable condition associated with a service performed by the IT infrastructure 102.

The monitoring layer 104 detects faults with the components and systems of the IT infrastructure 102 and violations associated with one or more contractual agreements 118. The contractual agreements 118 may comprise any type of agreement formed by an organization, such as service level agreements (SLAs). A service level agreement is a contract between an organization and a customer that guarantees specific levels of service for a pre-determined time interval at a pre-determined cost. For example, a service level agreement may guarantee that orders placed by a particular customer are processed within three days, or a 50% discount is applied to the purchase price. Thus, the monitoring layers may utilize the conditions and terms as set forth in the contractual agreements 118 and the service parameters 116 to determine when a violation associated with agreements occurs. The monitoring may occur continuously (i.e., in real-time) or periodically (e.g., once every five minutes).

A diagnosis layer 106 may receive notifications of the faults and contractual violations from the monitoring layer 104 and attempt to determine one or more causes of the faults and/or violations. A cause may represent any event capable of being detected by the diagnosis layer 106, such as an increased demand on a particular system and/or a non-operational IT component.

A recovery planning layer 108 may analyze the causes identified by the diagnosis layer 106 and produce a series of plans for correcting or rectifying the identified causes. For example, a first plan may be to repair a faulty IT component, and a second plan may be to order a new component and replace the faulty component. Each plan may be associated with one or more scheduling options, such as to repair the faulty component today or wait until tomorrow when a technician is available.

A contract-based analysis layer 110 may receive the plans formulated by the recovery-planning layer 108 and calculate the projected utility gain or loss associated with each plan. The contract-based analysis layer 110 may also rank the plans based on the projected utility and a particular scheduling option.

A reporting and notification layer 112 may display the ranked plans and associated utilities to a decision-maker, such as an IT manager or system operator. After a plan and associated scheduling option is chosen by the decision-maker, the reporting and notification layer 112 may notify the appropriate personnel of a selected plan of action.

As can be appreciated, the foregoing discussion is directed to the high-level management processes associated with an IT-related business decision. Various components of the IT infrastructure 102, such as servers, databases, and software applications, may be utilized to implement each of the layers 104-112. In addition, one or more of the layers 104-108 may be combined or modified as desired. For example, an organization may report faults and contractual violations immediately to a decision-maker while concurrently performing the functions associated with the diagnosis layer 106 and recovery planning 108 layer. The contract-based analysis layer 110 integrates contractual information into the management model 100 to provide a decision-maker with a calculation of utility based, in part, on the contractual agreements formed by the organization.

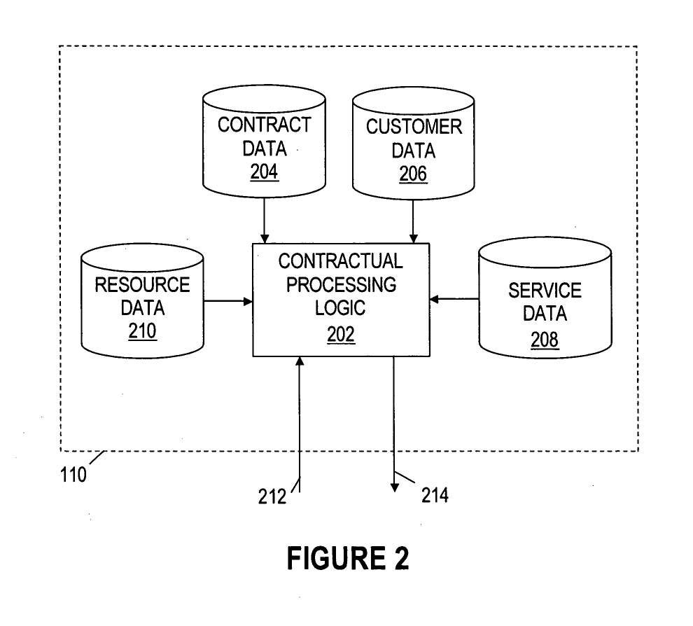

FIG. 2 illustrates the contract-based analysis layer 110 in accordance with embodiments of the invention. As shown, the contract-based analysis layer 110 comprises contractual processing logic 202 coupled to a plurality of data sources 204-210. The contractual processing logic 202 may comprise hardware and/or software designed to calculate the projected utility of one or more business plans. The hardware may comprise a microprocessor or any other type of programmable hardware, such as a programmable logic array (PLA) or programmable logic device (PLD). The software may comprise applications developed in C, C++, Java®, or any other suitable programming language.

Contract data 204 may contain information related to an organization's contractual agreements. Such agreements may comprise service level agreements (SLAs) that are associated with particular service level objectives (SLOs). The service level agreements may define minimum service levels for particular groups of customers and penalties if the service level falls below agreed upon values for the group.

Customer data 206 may contain information related to an organization's customers. Such information may comprise behavioral models based on past behavior of a customer group and other identifying information related to the customers of an organization.

Service data 208 may contain information related to an organization's IT services, such as email, network provisioning, online shops, or any other service performed by the IT infrastructure 102. Such information may comprise scheduling policies, current and/or predicted demand and costs associated with the services.

Resource data 210 may contain information related to an organization's resources, such as computer servers, systems, and applications. The resources may be utilized to operate the IT services. Such information may comprise the current availability of resources, the projected availability of resources, and costs associated with the resources.

Each data source 204-210 may be implemented via one or more instances of a database, an online analytical processing (OLAP) data store, a flat-file on a hard drive, or any other means for storing information. The contractual processing logic 202 utilizes the plans and associated scheduling options 212 formulated by the recovery planning layer 108 (FIG. 1), as well as the information contained within the data stores 204-210, to calculate the projected utility of plans and associated scheduling options formed by the recovery planning layer 108 (FIG. 1). The processing logic 202 outputs the calculated utility and ranked plans 214 based, in part, on the calculated utility.

For each plan and associated scheduling option, the contractual processing logic 202 may calculate a utility that comprises a strategic utility and a contract utility. The contract utility refers to utility gain or loss with respect to the contractual agreements 118. For exemplary purposes, consider a plan to upgrade a computer server. During the upgrade, an email service that utilizes the computer server may become inoperable. Four contractual agreements may be conditioned on the email service being operable during the projected period of inoperability. In this exemplary case, the contract utility represents the utility lost in accordance with the terms of the four contractual agreements. Strategic utility may refer to any utility outside the scope of the contract utility. For example, an organization may place a strategic utility on always meeting the agreements of high-priority customers. Thus, the contractual processing logic 202 calculates and aggregates a contract and strategic utility for each plan and associated scheduling option formed by the recovery planning layer 108 (FIG. 1).

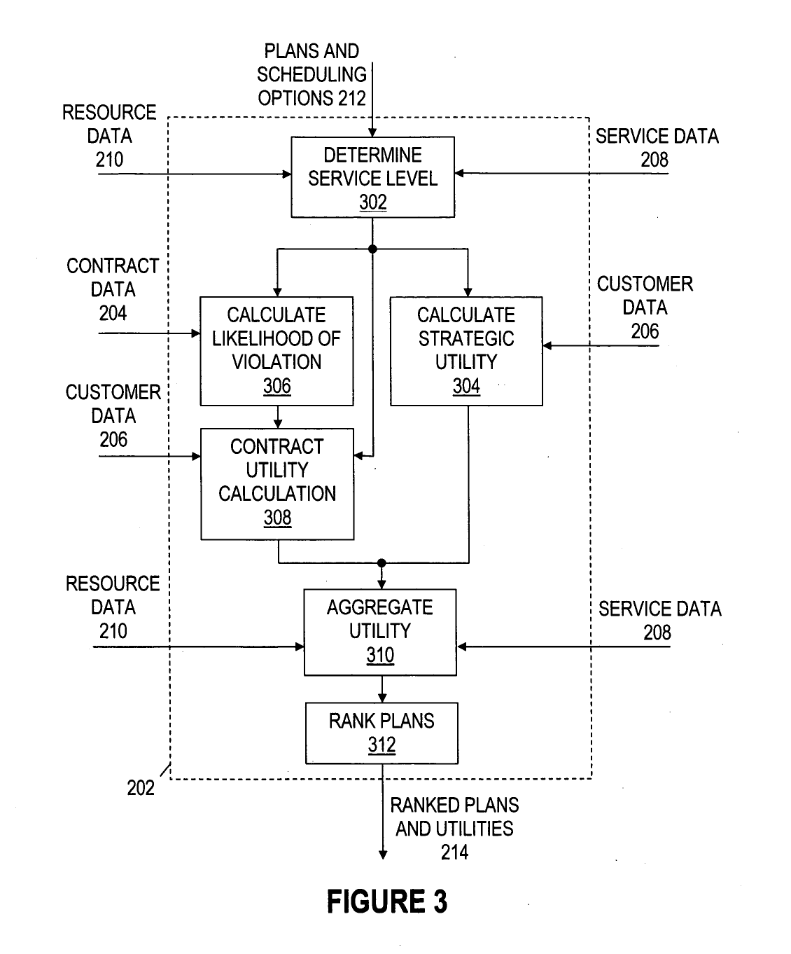

FIG. 3 depicts a procedure performed by the contractual processing logic 202 in accordance with embodiments of the invention. One or more plans and associated scheduling options 212 may be inputs to the processing logic 202. The service level of any affected resources may be determined (block 302) for each scheduling option associated with a plan. For example, a plan to repair an IT component may be capable of being scheduled on several days. Each day represents a scheduling option associated with the plan. As can be appreciated, the scheduling options may affect the utility of the plan. Thus, the service level for each plan with respect to each applicable scheduling option may be determined by the contractual processing logic 202. The scheduling options may be contained in the service data 208, and the projected availability of an organization's IT resources may be contained in the resource data 210.

After determination of the service level (block 302), a strategic utility (block 304) may be calculated. The strategic utility calculation (block 304), discussed more fully below, utilizes the customer data 206 and the determined service levels (block 302). A likelihood of contractual violation may also be calculated (block 306). The likelihood of contractual violation calculation (block 306) utilizes the contract data 204 and the determined service levels (block 302).

After calculating the likelihood of a contractual violation (block 306), a contract utility may be calculated (block 308). The calculation of the contract utility utilizes the likelihood of a contractual violation (block 306) and the customer data 206. The strategic utility (block 304) and contract utility (block 308) may be aggregated (block 310) and related to the cost values contained in the resource data 210 and the service data 208. After aggregation, the plans and associated scheduling options may be ranked based, in part, on the aggregated utility. The ranked plans and their corresponding utilities 214 are outputs of the contractual processing logic 202.

Since multiple plans and scheduling options may be generated by the recovery planning layer 108 (FIG. 1), the procedure performed in FIG. 3 may be executed recursively until each plan and associated scheduling option has a contract and strategic utility calculated and aggregated.

The contract utility calculation (block 308) represents the utility of a particular plan and scheduling option with respect to the contractual agreements formed by an organization. For example, a contractual agreement may be modeled by a series of clauses that represent undertakings that are contractually obligated to be fulfilled. Each clause may have an associated positive and negative consequence. The contract utility (U_{C}) of an undertaking (v) may be modeled by:
U_{C}(v,λ)=(1−λ)*(uᵥ+uₚ)+λuₙ (1)
where λ is the likelihood of a contractual violation, uᵥ is the direct utility of the undertaking, uₚ is the utility of the positive consequence, and uₙ is the utility of the positive consequence. For exemplary purposes, assume the following contractual agreement: “The time between an order and the corresponding shipment shall be less than 3 days; otherwise the cost of the order is fully refunded.” If we assume an order value of $1,000 and the likelihood of a violation is 20%, the resulting contract utility would be:
U_{C}(v,λ)=(1−0.2)*$1000+0.2(−$1000)=$600 (2)
During the contract utility calculation (block 308), the utility of a plan and associated scheduling option with respect to the contractual agreements is calculated.

The strategic utility calculation (block 304) may incorporate utilities that are not included as part of the contract utility calculation (block 308). The strategic utility may account for various factors, such as a service level objective (SLO) utility, a customer strategic utility, and an organizational strategic utility. The service level objective utility may represent the value of an outcome with respect to an objective. An organization may place a higher value on complying with the objectives of a strategic partner than with a second-tier partner. Thus, the service level objective utility takes into account information not included in the contract utility, such as the strategic value of particular partnerships and the damage incurred by violating an objective associated with a particular partner.

The customer strategic utility may represent the value of an outcome independently of the service level objectives. For example, an organization may have a strategic policy to always guarantee a certain level of service for a particular customer, regardless of what objectives are in place. The customer strategic utility takes into account the value of these customer-centric strategic polices.

The organizational strategic utility may represent the value of policies independent of a particular customer objective. For example, an organization may have a strategic policy to always process orders within a defined time period. The organizational strategic utility takes into account the value of these organization-wide strategic polices. Additional utilities may be included as desired.

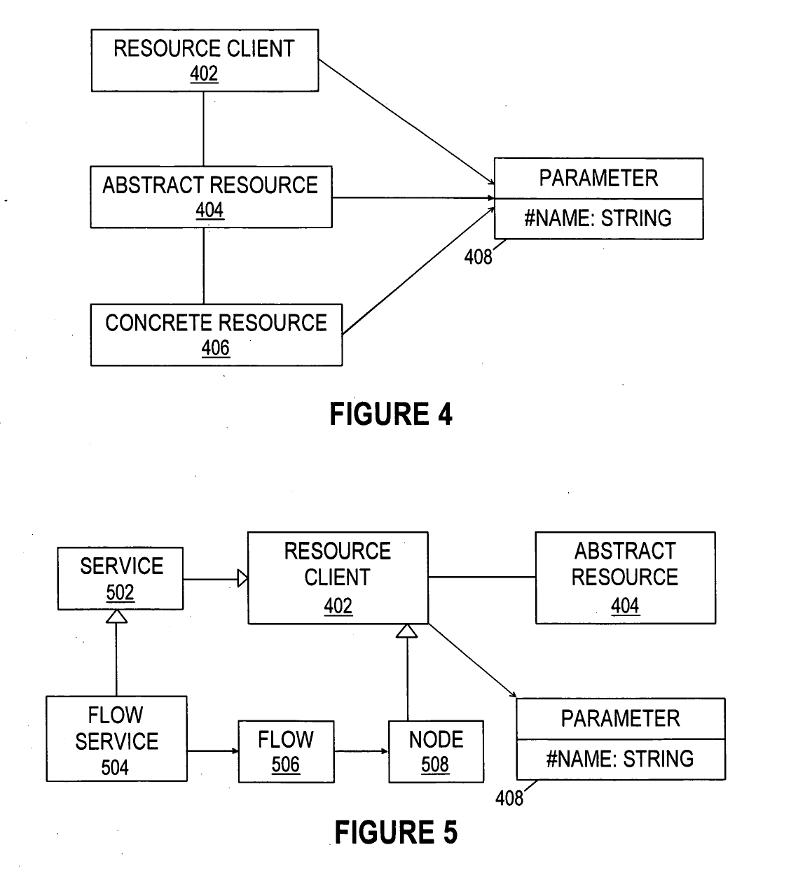

FIGS. 4-9 illustrate exemplary object classes that may be utilized to implement embodiments of the invention. Each object class is illustrated as a uniform modeling language (UML) class diagram. Uniform modeling language is an industry-standard language for specifying, visualizing, constructing, and documenting the artifacts of software systems. For additional information, see the Object Management Group's (OMG) UML Specification, entitled “OMG Unified Modeling Language, v 1.5,” incorporated herein be reference.

FIG. 4 illustrates a UML class diagram of a resource in accordance with embodiments of the invention. A resource client 402 may model any type of IT resource, such as systems, applications, services, and business processes. The resource client 402 is associated with one or more abstract resources 404, which are associated with one or more concrete resources 406. The resource client 402, abstract resource 404, and concrete resource 406 are binded by one or more parameters 408. Each parameter 408 may be associated with a name attribute (“#NAME”). The concrete resource 406 may represent any tangible organizational resource, such as a computer system, a server, and/or an instance of a database.

FIG. 5 illustrates a class diagram of a service in accordance with embodiments of the invention. A service 502 may be inherited by a resource client 402. As previously discussed, the resource client 402 is associated with one or more abstract resources 404 and binded by one or more parameters 408. When the service represents a business process a flow service 504 may inherit the service 502. The flow service 504 may be binded by one or more flows 506, which are binded by one or more nodes 508. Thus, a business process is expressed as an ordered set of nodes 508. The resource client 402 may be a superclass of the nodes 508.

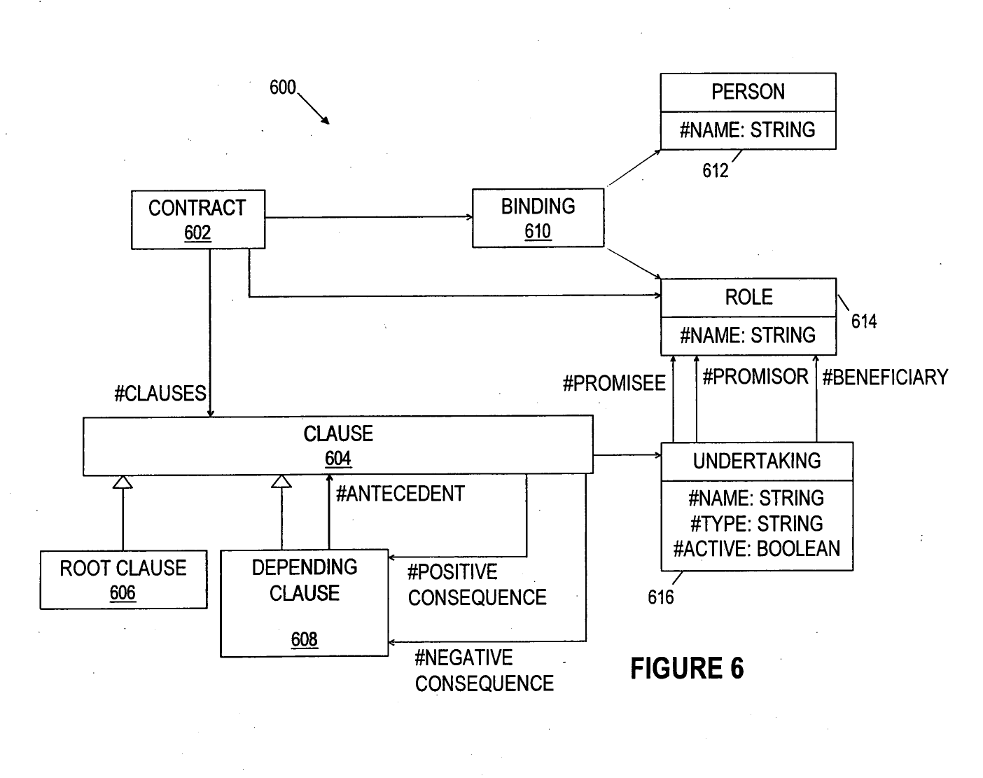

FIG. 6 illustrates a class diagram of a contract information model 600 in accordance with embodiments of the invention. As shown in FIG. 6, a contract 602 may provide a collection of clauses 604 that define an undertaking 616 that is promised as well as positive and negative consequences for completing or not completing each undertaking. Each clause 604 may be based on a root clause 606 and a depending clause 608. The root clause 606 may provide undertaking information that does not change to the clause 604. The depending clause 608 may provide antecedents to the clause 604 based on the positive and negative consequences. For example, the antecedents may be based on the results of positive and negative consequences that occurred in the past. Additionally or alternatively, the antecedents may be customer specific and may be based on customer input.

The contract information model 600 simulates a dynamic contract (i.e., a contract with provisions that change according to parameters such as time or occurrence of predetermined circumstances. Therefore, the undertakings 616 provided by the clauses 604 may be active or inactive as indicated by a Boolean (or equivalent) value (“#ACTIVE”). Each undertaking 616 also may comprise a name designation (“NAME”) and a type designation (“TYPE”).

As shown in FIG. 6, each undertaking 616 may output a promisee, a promisor, and a beneficiary that is associated with a role 614. For example, the role 614 may be as a buyer, a service provider or another role associated with the contract 602. The contract 602 also may provide bindings 610 that associate persons 612 (e.g., individuals) with each role 614.

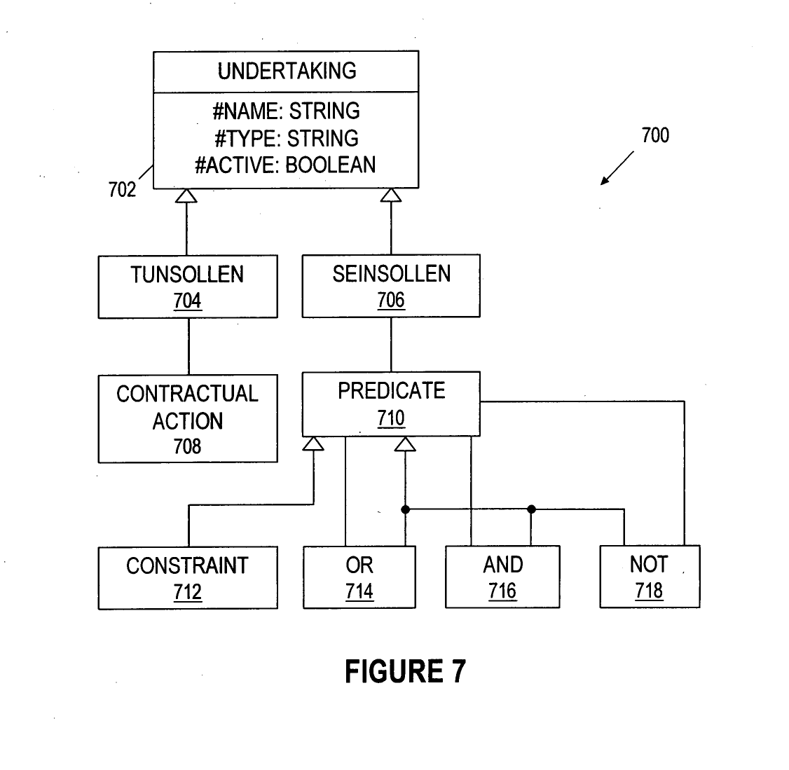

FIG. 7 illustrates a class diagram of an undertaking model 700 in accordance with embodiments of the invention. As shown in FIG. 7, an undertaking 702 may be received via a Tunsollen block 704 or a Seinsollen block 706. The Tunsollen block 704 is associated with “ought-to-do” undertakings (i.e., promises of bringing about a certain state of affairs). For example, the Tunsollen block 704 may receive input from known contractual actions 708. The Seinsollen block 706 is associated with “ought-to-be” undertakings (i.e., promises of carrying out a certain contractual action). As shown, the Seinsollen block 706 may be based on a predicate 710 (i.e., logical arguments and/or connectives) such as a constraint 712 as well as OR parameters 714, AND parameters 716, and NOT parameters 718.

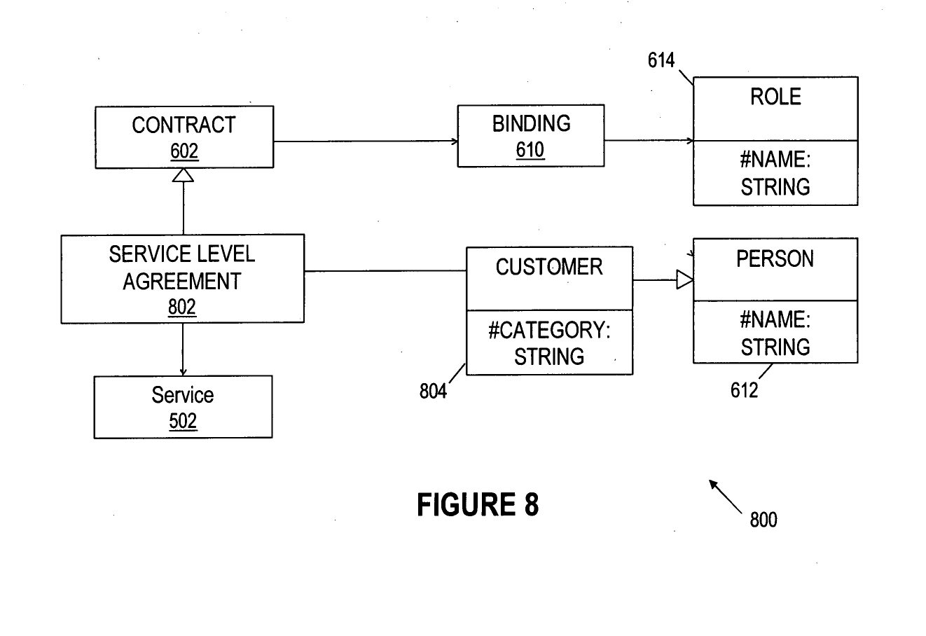

FIG. 8 illustrates a class diagram of a SLA model 800. As shown in FIG. 8, a SLA 802 may be a type of contract 602 that is defined over a service 502. The SLA 802 may define a customer 804 that is associated with a person definition 612. The contract 602 may define a binding 610 that associates a role 614 with the person definition 614.

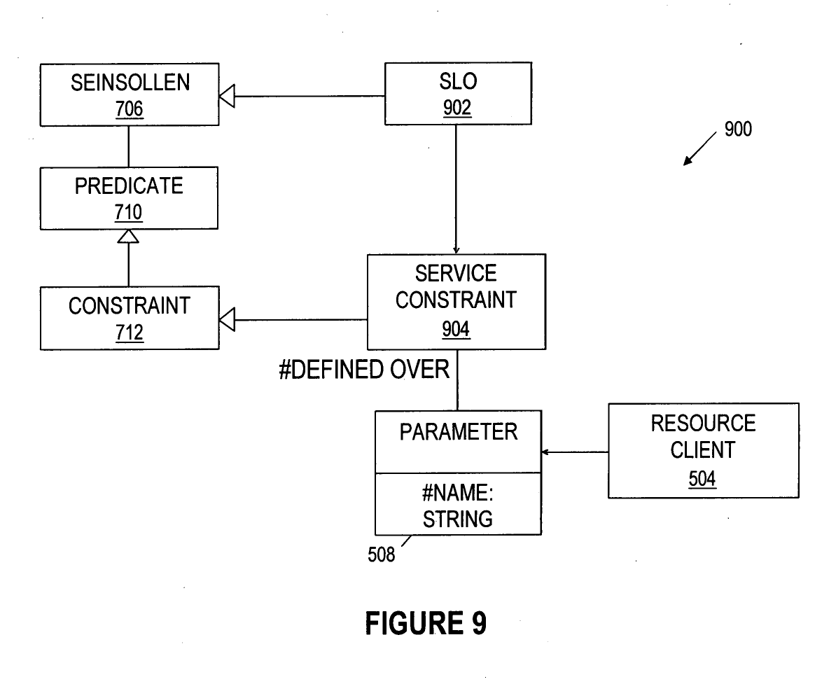

FIG. 9 illustrates a class diagram of a SLO model 900. As shown in FIG. 9, an SLO 902 may be associated with a Seinsollen 706 that is based on a predicate 710 that includes a constraint input 712. The constraint 712 may be based on a service constraint 904 that is defined over parameters 508 of a resource client 504.

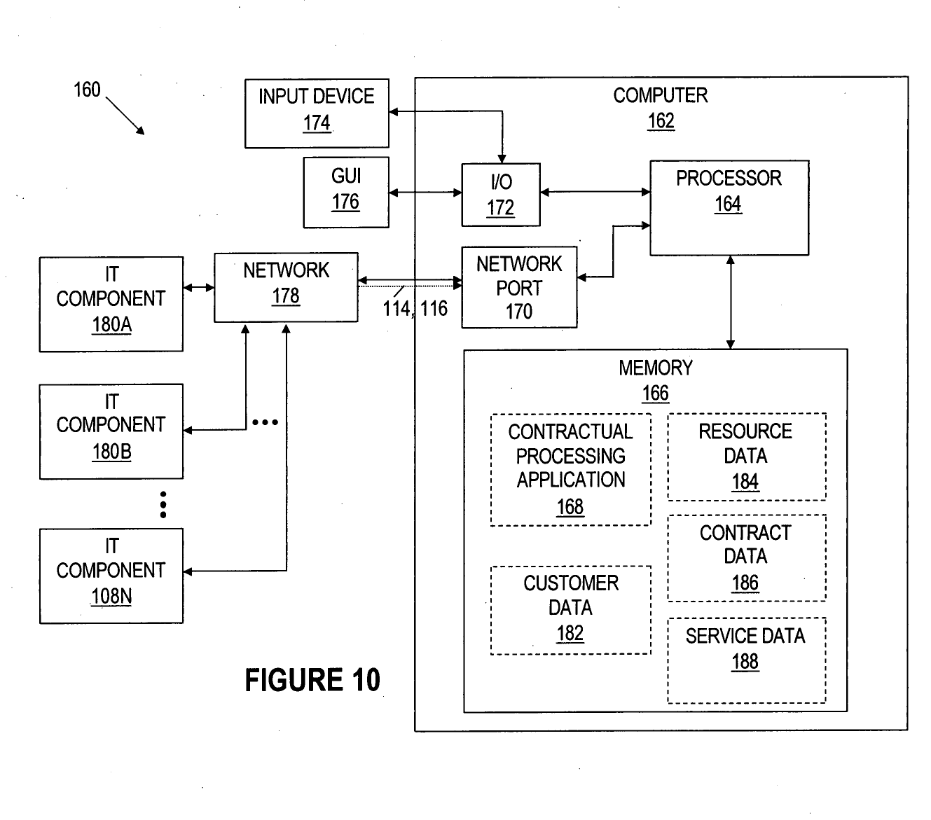

FIG. 10 illustrates a system 160 in accordance with embodiments of the invention. As shown in FIG. 10, the system 160 may comprise a computer 162 having a processor 164 coupled to a memory 166. The memory 166 may store a contractual processing application 168 that, when executed, causes the processor 164 to perform the function of the contractual processing logic 202 described in FIGS. 2 and 3. The memory 166 also may store customer data 182, resource data 184, contract data 186 and service data 188 that relate to the customer data 206, resource data 210, contract data 204 and service data 208 described previously for FIG. 2. The customer data 182, resource data 184, contract data 186 and service data 188 may be accessed during execution of the contractual processing application 168 to allow the monitoring, diagnosis, recovery planning, contract-based analysis, reporting and notification processes described in FIG. 1.

As shown, the computer 162 may couple to a plurality of IT components 180A-180N via a network 178 and a network port 170. The network port 170 may couple to the processor 164 and allows communication between elements (e.g., the IT components 180A-180N) coupled to the network 178 and the processor 164. For example, the IT components 180A-180N may supply the status information 114 and the service parameters 116 described previously for FIG. 1 to the processor 164 via the network 178 and the network port 170. The processor 164 may use the status information 114 and the service parameters 116 to determine whether faults have occurred in the IT components 180A-180N or whether violations of contract terms (e.g., SLAs) have occurred.

The processor 164 also may couple to a graphic use interface (GUI) 176 and an input device 174 via an input port 172. The input device 172 may be, for example, a keyboard or a mouse. Execution of the contractual processing application 168 may cause an application window to appear on the GUI 176 such that a user of the computer 162 may view the results of the monitoring, diagnosis, recovery planning, contract-based analysis, reporting and notification processes that are performed.

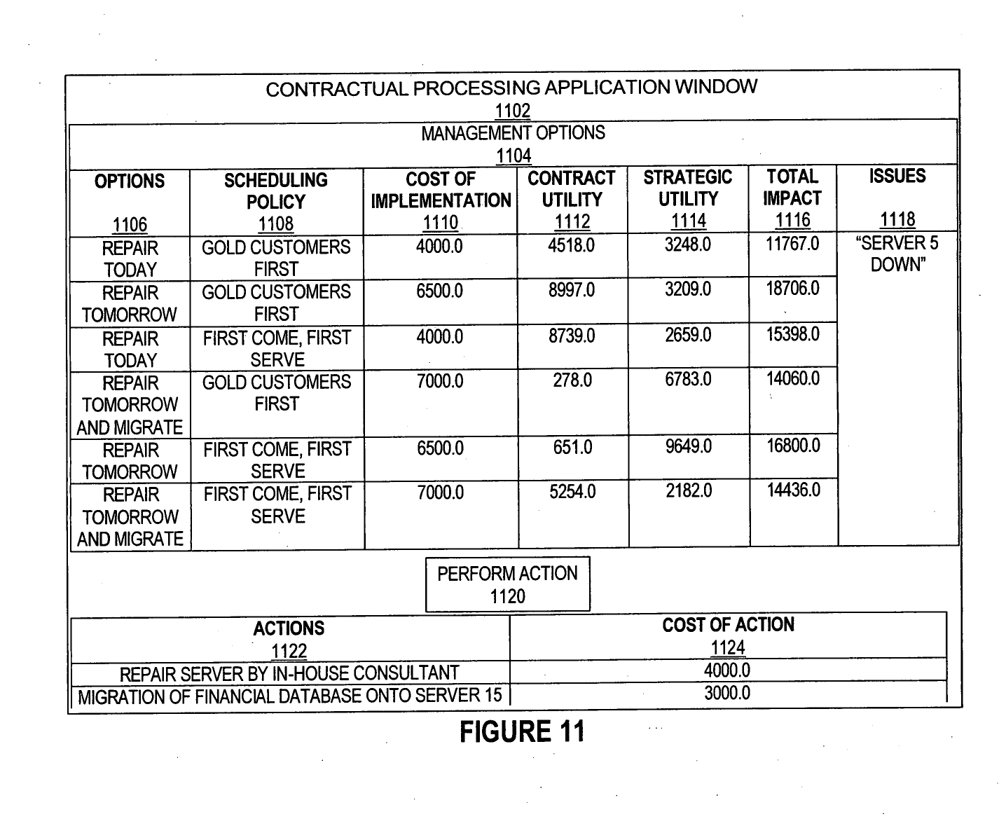

FIG. 11 illustrates a contractual processing application window 1102 in accordance with embodiments of the invention. As shown in FIG. 11, the window 1102 may display management options 1104. The management options 1104 may be organized into columns and rows of information although other formats are possible. The management options 1104 may be organized under the headings: OPTIONS 1106, SCHEDULING POLICY 1108, COST OF IMPLEMENTATION 1110, CONTRACT UTILITY 1112, STRATEGIC UTILITY 1114, TOTAL IMPACT 1116, and ISSUES 1118.

Under the OPTIONS heading 1106 a list of possible options related to recovery planning may be displayed. For example, the options may be “repair today,” “repair tomorrow,” or “repair tomorrow and migrate.” Under the SCHEDULING POLICY heading 1108, a list of possible scheduling policies may be displayed. For example, the scheduling policies may comprise “gold customers first” or “first come, first serve.” Under the COST OF IMPLEMENTATION heading 1110, a calculated cost associated with each option and scheduling policy group may be displayed. Under the CONTRACT UTILITY heading 1112, a calculated utility cost associated with each option and scheduling policy group may be displayed. Under the STRATEGIC UTILITY heading 1114, a calculated strategic cost associated with each option and scheduling policy group may be displayed. Under the TOTAL IMPACT heading 1116, a total cost associated with each option and scheduling policy group may be displayed. Under the ISSUES heading 1118, one or more text messages may be displayed. The test messages may provide information regarding issues related to the management options. For example, a message such as “server 5 down” may be displayed.

The contractual processing application window 1102 also may display a selectable button 1120 (labeled “PERFORM ACTION”) that allows a user to select (e.g., via the input device 174) one of the possible actions to be performed. As shown, one or more possible actions may be displayed under an ACTIONS heading 1122. Also, a calculated cost of performing the action may be displayed under a COST OF ACTION 1124 heading. For example, the user may highlight an action by clicking a mouse button. Once the action is highlighted, the user may select the action by clicking on the selectable button 1120. Information that identifies the selected action may be forwarded for reporting/notification purposes to a decision-maker that has access to the computer 162 (e.g., via the input device 174, GUI 176, or network 178).

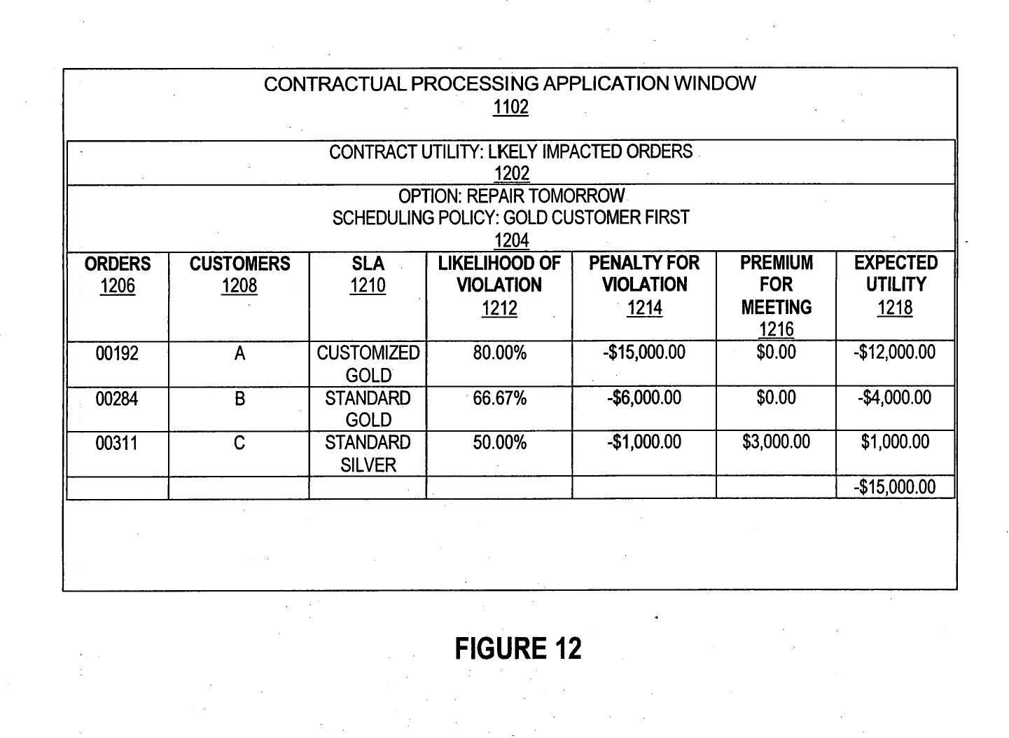

FIG. 12 illustrates contract utility information shown in a contractual processing application window 1102 in accordance with embodiments of the invention. As shown in FIG. 12, the window 1102 may display a CONTRACT UTILITY heading 1202. The window 1102 also may display an option and scheduling policy pair 1204 that is associated with the contract utility. Information related to the contract utility may be organized under the headings: ORDERS 1206, CUSTOMERS 1208, SLA 1210, LIKELIHOOD OF VIOLATION 1212, PENALTY FOR VIOLATION 1214, PREMIUM FOR MEETING 1216, and EXPECTED UTILITY 1218.

Under the ORDERS heading 1206, a list of order numbers may be displayed. Under the CUSTOMERS heading 1208, a list of customers associated with each order number may be displayed. Under the SLA heading 1210, service level agreements associated with each customer may be displayed. Under the LIKELIHOOD OF VIOLATION heading 1212, a calculated likelihood of violating the service level agreement may be displayed. The calculation may be based on the selected option (e.g., repair tomorrow) and the selected scheduling policy (e.g., gold customer first). Under the PENALTY FOR VIOLATION heading 1214, a calculated penalty (e.g., a monetary penalty) for violating the service level agreement may be displayed. Under the PREMIUM FOR MEETING heading 1216, a premium (e.g., a monetary premium) for meeting the conditions of the service level agreement may be displayed.

Under the EXPECTED UTILITY heading 1218, a calculated “expected utility” of the selected option and the selected scheduling policy may be displayed. The expected utility calculation may be based on the likelihood of violation, the penalty for violation, and the premium for meeting. For example, if the likelihood of violation is 50%, the penalty of violation is −$1,000, and the premium for meeting is $3,000, the expected utility may be calculated as −1,000*0.5 (i.e., the penalty of violation times the likelihood of violation) plus 3,000*0.5 (the premium for meeting times the likelihood of meeting). The total of the expected contract utilities of the selected option and the selected scheduling policy also may be displayed.

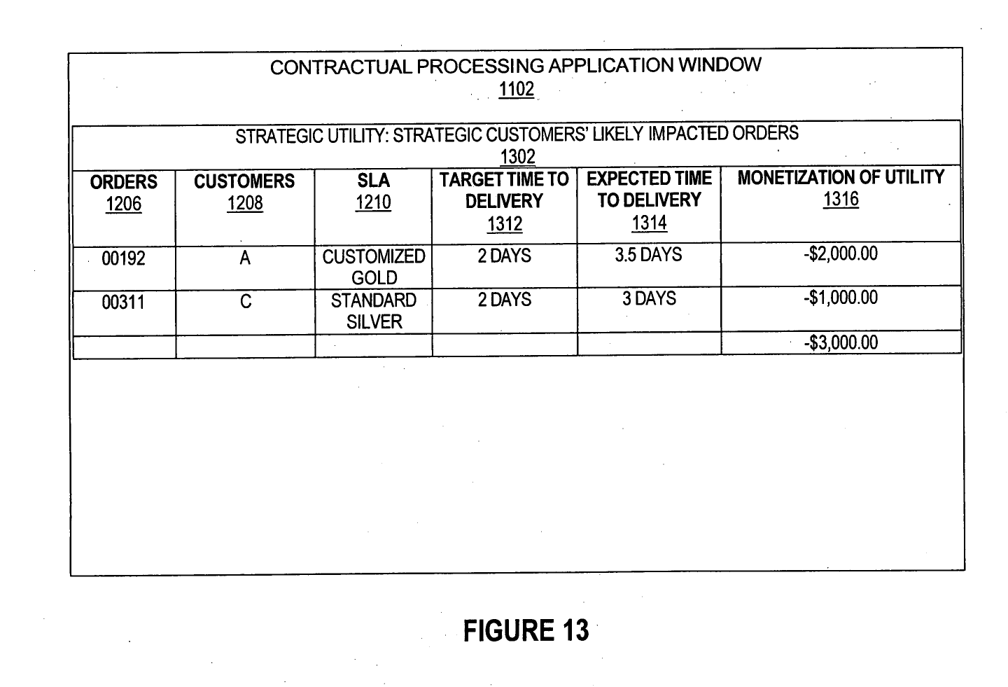

FIG. 13 illustrates strategic utility information shown in a contractual processing application window 1102 in accordance with embodiments of the invention. As shown in FIG. 13, the window 1102 may display a STRATEGIC UTILITY heading 1302. Information related to the strategic utility may be organized under the headings: ORDERS 1206, CUSTOMERS 1208, SLA 1210, TARGET TIME TO DELIVERY 1312, EXPECTED TIME TO DELIVERY 1314, and MONETIZAZTION OF UTILITY 1316.

The ORDERS heading 1206, the CUSTOMERS heading 1208, and the SLA heading 1210 shown in FIG. 13 may display information as was described for FIG. 12. Additionally, under the TARGET TIME TO DELIVERY heading 1312, a target period for service delivery to each customer may be displayed. For example, the target time period may prevent violation of a service level agreement. Under the EXPECTED TIME TO DELIVERY heading 1314, an expected time period for service delivery to each customer may be displayed. Under the MONETIZATION OF UTLIT Y heading 1316, a calculated monetization of the strategic utility may be displayed. As shown, when the expected time to delivery is greater than the target time to delivery, the monetization of utility may be negative (i.e., a monetary loss results). The total of the expected strategic utilities also may be displayed. A decision-maker may view the management information, the contract utility information, and the strategic utility information displayed in the application window 1102.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
receiving parameters of an information technology (IT) infrastructure;
formulating one or more IT recovery plans based on the parameters; and
calculating a projected utility for one or more of the IT recovery plans based on one or more contractual agreements.

2. The method of claim 1 wherein the parameters comprise information that represents the operational status of one or more components of the IT infrastructure.

3. The method of claim 1 wherein the parameters comprise information that represents measurable conditions associated with services performed by the IT infrastructure.

4. The method of claim 1 wherein calculating a projected utility for each one of the IT recovery plans is further based on at least one utility selected from the group consisting of a service level utility, a strategic customer utility and a strategic organizational utility.

5. The method of claim 1 wherein the projected utility comprises one of a projected monetary gain and a projected monetary loss.

6. A system, comprising:
contractual processing logic; and
a contract data source configured to provide contract information associated with one or more contractual agreements to the contractual processing logic,
wherein the contractual processing logic is configured to receive plans and scheduling options to correct a violation of the one or more contractual agreements and calculate a projected cost associated with implementing combinations of the plans and the scheduling options.

7. The system of claim 6 wherein the violation has not yet occurred.

8. The system of claim 6 further comprising:
a resource data source configured to provide resource information associated with one or more information technology (IT) resources to the contractual processing logic; and
a service data source configured to provide service information associated with one or more IT services to the contractual processing logic,
wherein the contractual processing logic determines a service level of IT resources affected by each of the combinations of the plans and the scheduling options based on the resource information and the service information.

9. The system of claim 8 wherein the contractual processing logic calculates a likelihood of contract violation value based on the contract information and the service level.

10. The system of claim 9 further comprising a customer data source configured to provide customer information to the contractual processing logic, wherein the contractual processing logic calculates a contract utility cost based on the service level, the customer information, and the likelihood of contract violation value.

11. The system of claim 10 wherein the customer information comprises behavioral models based on past behavior of one or more customers.

12. The system of claim 10 wherein the contractual processing logic further calculates a strategic utility cost based on the service level and the customer information.

13. The system of claim 12 wherein the projected cost is calculated based on the contract utility cost and the strategic utility cost.

14. The system of claim 10 wherein the contract data source, the resource data source, the service data source and the customer data source comprise at least one storage medium selected from the group consisting of a database, an OLAP data store and a file stored on a hard drive.

15. The system of claim 6 wherein the contractual processing logic is further configured to rank the combinations of the plan and the scheduling options.

16. The system of claim 6 wherein the one or more contractual agreements are modeled for interpretation by the contractual processing logic using uniform modeling language (UML).

17. A computer system, comprising:
a processor;
a graphic user interface (GUI) coupled to the processor; and
a memory coupled to the processor,
wherein the memory stores contract data and a contractual processing application that, when executed, causes the processor to calculate a projected utility of one or more information technology (IT) recovery plans based on the contract data and display the projected utility on the GUI.

18. The computer system of claim 17 wherein the memory further stores resource data that provides resource information associated with one or more IT resources to the processor and service data that provides service information associated with one or more IT services to the processor and wherein the contractual processing application, when executed, causes the processor to determine a service level of IT resources affected by the one or more IT recovery plans based on the resource data and the service data.

19. The computer system of claim 18 wherein the contractual processing application, when executed, causes the processor to calculate a likelihood of violation percentage of one or more contractual agreements based on the service level and the contract data.

20. The computer system of claim 19 wherein the memory further stores customer behavior models and wherein the contractual processing application, when executed, causes the processor to calculate a contract utility value based on the likelihood of violation percentage and at least one of the customer behavior models.

21. The computer system of claim 20 wherein the contractual processing application, when executed, causes the processor to calculate a strategic utility value based on the service level and at least one of the customer behavior models.

22. The computer system of claim 21 wherein the projected utility is based on the contract utility value and the strategic utility value.

23. The computer system of claim 17 further comprising a network port coupled to the processor, wherein the network port is configured to couple to one or more IT components that provide status information and service parameters to the processor whereby the IT recovery plans are generated.

24. A storage medium containing computer readable instructions that are executable by a computer and cause the computer to:
calculate a projected cost of one or more IT recovery plans based on contractual service level agreements; and
display the projected cost on a graphic user interface.

25. The storage medium of claim 24 wherein the computer readable instructions further cause the computer to:
display IT recovery options;
display scheduling policies associated with each of the IT recovery options; and
permit user-selection of an IT recovery option and a scheduling policy.

26. The storage medium of claim 25 wherein the computer readable instructions further cause the computer to display contract utility information when a user selects an IT recovery option and a scheduling policy.

27. A system, comprising:
means for determining a cause of at least one of an IT fault and a contractual violation;
means for generating one or more recovery plans for each IT fault and contractual violation; and
means for calculating a projected utility of the one or more recovery plans based on contractual agreements.

28. The system of claim 27 further comprising means for monitoring status information and service parameters of an information technology (IT) infrastructure coupled to the means for determining a cause, wherein the means for determining a cause implements the status information and the service parameters.

29. The system of claim 27 further comprising means for ranking the one or more recovery plans based on the projected utility.
